(19) United States
(12) Patent Application Publication
(10) Pub. No.: US 2016/0335548 A1
(43) Pub. Date: Nov. 17, 2016

(54) METHODS AND APPARATUS FOR PREDICTING FAULT OCCURRENCE IN MECHANICAL SYSTEMS AND ELECTRICAL SYSTEMS

(71) Applicant: ROLLS-ROYCE plc, London (GB)

(72) Inventors: Chi-Keong GOH, Singapore (SG); Lim PIN, Singapore (SG); Tan KAY CHEN, Singapore (SG)

(73) Assignee: ROLLS-ROYCE plc, London (GB)

(21) Appl. No.: 15/141,197

(22) Filed: Apr. 28, 2016

(30) Foreign Application Priority Data
May 12, 2015 (GB) 1508032.8

(51) Int. Cl. G06N 5/04; G06N 3/12

(52) U.S. Cl. CPC G06N 5/04; G06N 3/126

(57) ABSTRACT

A method for predicting fault occurrence in a mechanical system and an electrical system. The method comprises: receiving a first dataset of mechanical system condition data, the first dataset being imbalanced by having more data points in a first category than in a second category; generating a plurality of chromosomes from the second category data points in the first dataset; the plurality of chromosomes including information to enable the creation of new datasets; generating a second dataset using the plurality of chromosomes and an evolutionary algorithm, the second dataset being less imbalanced than the first dataset; and predicting fault occurrence in the mechanical system using the second dataset and a machine learning algorithm.

### TECHNOLOGICAL FIELD

The present disclosure concerns apparatus and methods for predicting fault occurrence in mechanical systems and electrical systems.

### BACKGROUND

Mechanical systems, such as gas turbine engines, usually include sensors for sensing the condition of the mechanical system. The sensor data may be used within a machine learning method to automatically distinguish between faulty conditions and non-faulty conditions to predict when a fault may occur in the mechanical system. The prediction of fault occurrence may be used to predict the remaining useful life of the mechanical system.

In some mechanical systems, the dataset provided by the sensors is imbalanced in that the majority of data points relate to non-faulty conditions and a minority of data points relate to faulty conditions. For example, in gas turbine engines, the vast majority of data points relate to non-faulty conditions, and a small minority of data points relate to faulty conditions.

Machine learning methods usually perform poorly on imbalanced datasets since they tend to identify all data as belonging to the majority class (that is, non-faulty for gas turbine engines). This may lead to an inaccurate prediction of fault occurrence of the mechanical system. In order to compensate for the inaccuracy of the prediction, the operator of the mechanical system may increase the frequency at which the mechanical system is maintained. However, this may increase the maintenance cost to the operator and may result in the mechanical system being placed out of use more frequently than necessary.

### BRIEF SUMMARY

According to various, but not necessarily all, embodiments there is provided a method of predicting fault occurrence in a mechanical system, the method comprising: receiving a first dataset of mechanical system condition data, the first dataset being imbalanced by having more data points in a first category than in a second category; generating a plurality of chromosomes from the second category data points in the first dataset; the plurality of chromosomes including information to enable the creation of new datasets; generating a second dataset using the plurality of chromosomes and an evolutionary algorithm, the second dataset being less imbalanced than the first dataset; and predicting fault occurrence in the mechanical system using the second dataset and a machine learning algorithm.

According to various, but not necessarily all, embodiments there is provided a method of balancing a dataset, the method comprising: receiving a first dataset, the first dataset being imbalanced by having more data points in a first category than in a second category; generating a plurality of chromosomes from the second category data points in the first dataset; the plurality of chromosomes including information to enable the creation of new datasets; generating a second dataset using the plurality of chromosomes and an evolutionary algorithm, the second dataset being less imbalanced than the first dataset.

Generating the second dataset may include: iteratively generating a plurality of datasets using the evolutionary algorithm and the plurality of generated chromosomes; and selecting the second dataset from the plurality of iteratively generated datasets.

The method may further comprise: generating a plurality of second datasets from a subset of the plurality of chromosomes; training a plurality of classifiers using the plurality of second datasets; combining the plurality of classifiers to form an ensemble; and wherein predicting fault occurrence in the mechanical system uses the ensemble.

The evolutionary algorithm may be a single objective evolutionary algorithm.

The evolutionary algorithm may be a multi-objective evolutionary algorithm.

The information to enable the creation of new datasets may include an interpolation factor.

The information to enable the creation of new datasets may include information for the number of new data points to be generated within a hypervolume.

The information to enable the creation of new datasets may include a probability landscape to enable generation of new data points.

The information to enable the creation of new datasets may only encode parameters for defining clusters and a data generation method.

The first category may be a non-faulty condition of the mechanical system and the second category is a faulty condition of the mechanical system.

The method may further comprise controlling presentation of the predicted fault occurrence in the mechanical system.

The mechanical system may comprise a gas turbine engine.

According to various, but not necessarily all, embodiments there is provided apparatus for predicting fault occurrence in a mechanical system, the apparatus comprising: processor circuitry configured to: receive a first dataset of mechanical system condition data, the first dataset being imbalanced by having more data points in a first category than in a second category; generate a plurality of chromosomes from the second category data points in the first dataset; the plurality of chromosomes including information to enable the creation of new datasets; generate a second dataset using the plurality of chromosomes and an evolutionary algorithm, the second dataset being less imbalanced than the first dataset; and predict fault occurrence in the mechanical system using the second dataset and a machine learning algorithm.

According to various, but not necessarily all, embodiments there is provided apparatus for balancing a dataset, the apparatus comprising processor circuitry configured to: receive a first dataset, the first dataset being imbalanced by having more data points in a first category than in a second category; generate a plurality of chromosomes from the second category data points in the first dataset; the plurality of chromosomes including information to enable the creation of new datasets; generate a second dataset using the plurality of chromosomes and an evolutionary algorithm, the second dataset being less imbalanced than the first dataset.

The processor circuitry may be configured to iteratively generate a plurality of datasets using the evolutionary algorithm and the plurality of generated chromosomes; and select the second dataset from the plurality of iteratively generated datasets.

The processor circuitry may be configured to: generate a plurality of second datasets from a subset of the plurality of chromosomes; train a plurality of classifiers using the plurality of second datasets; combine the plurality of classifiers to form an ensemble. Predicting fault occurrence in the mechanical system may use the ensemble.

The evolutionary algorithm may be a single objective evolutionary algorithm.

The evolutionary algorithm may be a multi-objective evolutionary algorithm.

The information to enable the creation of new datasets may include an interpolation factor.

The information to enable the creation of new datasets may include information for the number of new data points to be generated within a hypervolume.

The information to enable the creation of new datasets may include a probability landscape to enable generation of new data points.

The information to enable the creation of new datasets may only encode parameters for defining clusters and a data generation method.

The first category may be a non-faulty condition of the mechanical system and the second category may be a faulty condition of the mechanical system.

The processor circuitry may be configured to control an output device to present the predicted fault occurrence in the mechanical system.

The mechanical system may comprise a gas turbine engine.

According to various, but not necessarily all, embodiments there is provided a system comprising: a mechanical system; apparatus as described in any of the preceding paragraphs; and one or more sensors configured to sense a condition of the mechanical system, and to provide the first dataset to the apparatus.

According to various, but not necessarily all, embodiments there is provided a computer program that, when read by a computer, causes performance of the method as described in any of the preceding paragraphs.

According to various, but not necessarily all, embodiments there is provided a non-transitory computer readable storage medium comprising computer readable instructions that, when read by a computer, causes performance of the method as described in any of the preceding paragraphs.

The skilled person will appreciate that except where mutually exclusive, a feature described in relation to any one of the above aspects of the invention may be applied mutatis mutandis to any other aspect of the invention.

### BRIEF DESCRIPTION

Embodiments of the invention will now be described by way of example only, with reference to the Figures, in which:

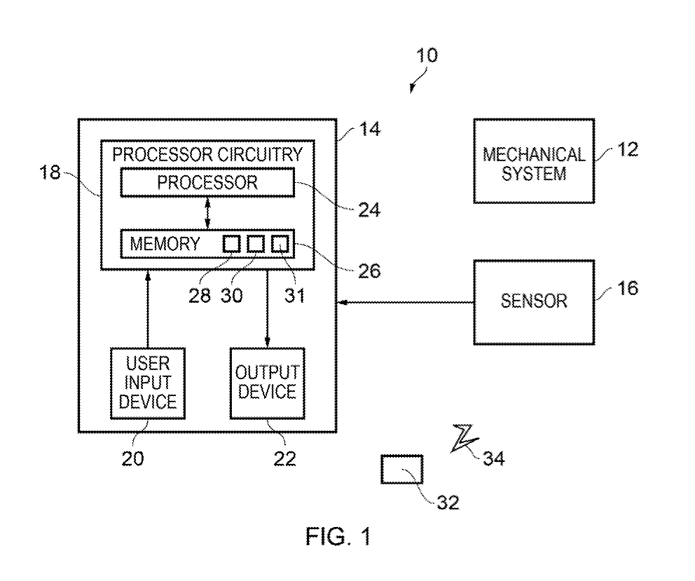

FIG. 1 illustrates a schematic diagram of a system according to various examples;

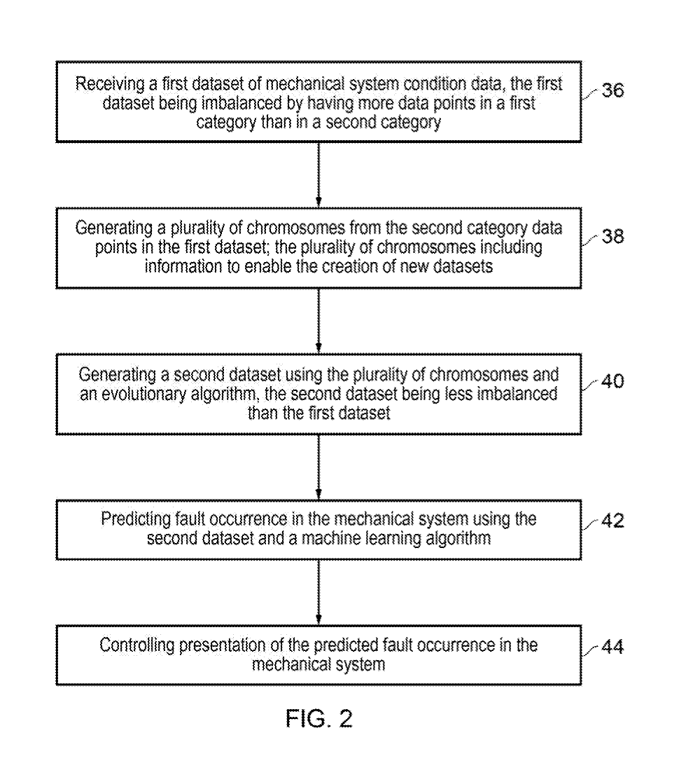

FIG. 2 illustrates a flow diagram of a method of predicting fault occurrence in a mechanical system according to various examples;

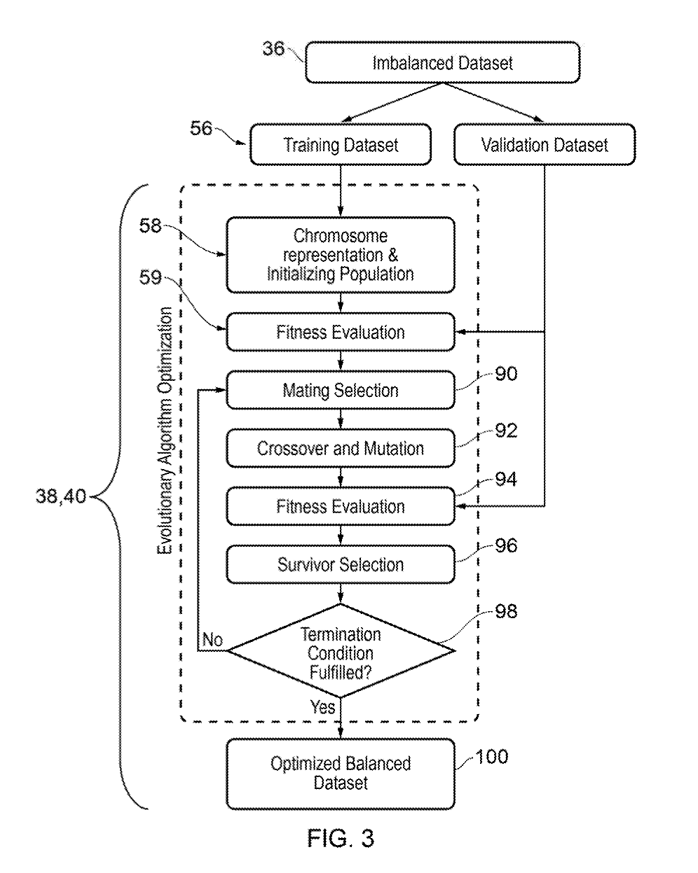

FIG. 3 illustrates a flow diagram of a method of balancing a dataset according to various examples;

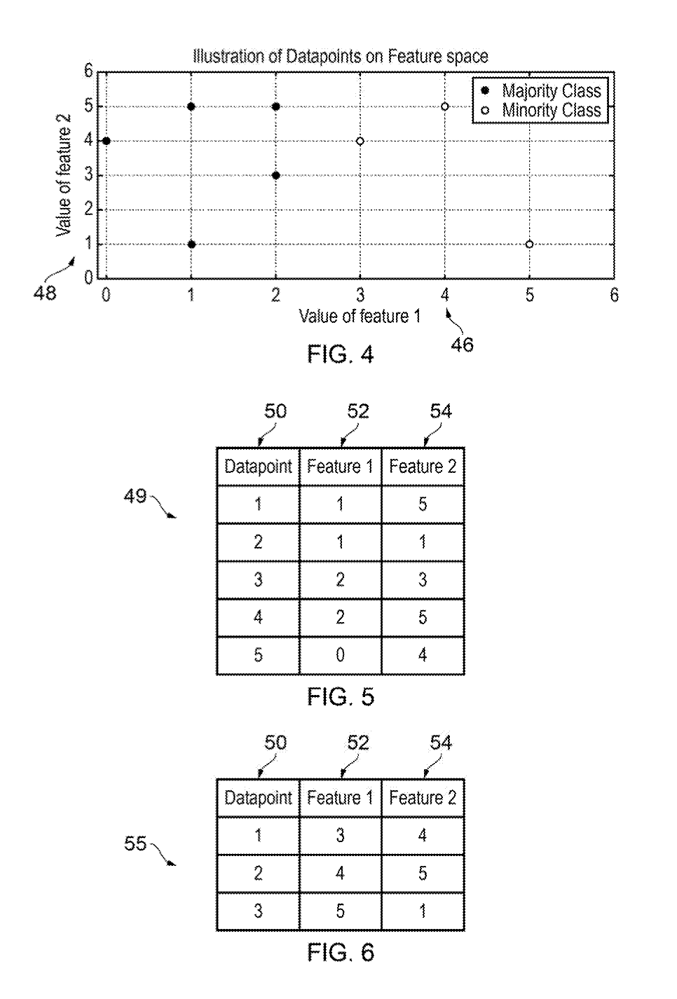

FIG. 4 illustrates a graph of the data points of a dataset according to an example;

FIG. 5 illustrates a table of data points of the dataset illustrated in FIG. 4 in a first category according to an example;

FIG. 6 illustrates a table of data points of the dataset illustrated in FIG. 4 in a second category according to an example;

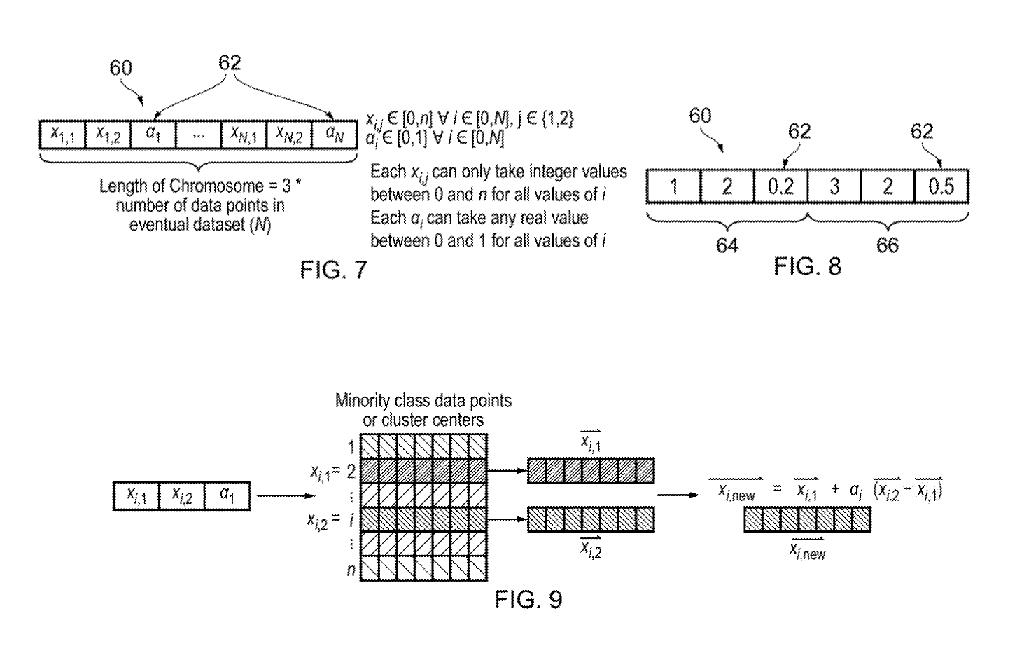

FIG. 7 illustrates a schematic diagram of a first chromosome according to various examples;

FIG. 8 illustrates a schematic diagram of an example of a first chromosome;

FIG. 9 illustrates an algorithm for calculating a new data point according to various examples;

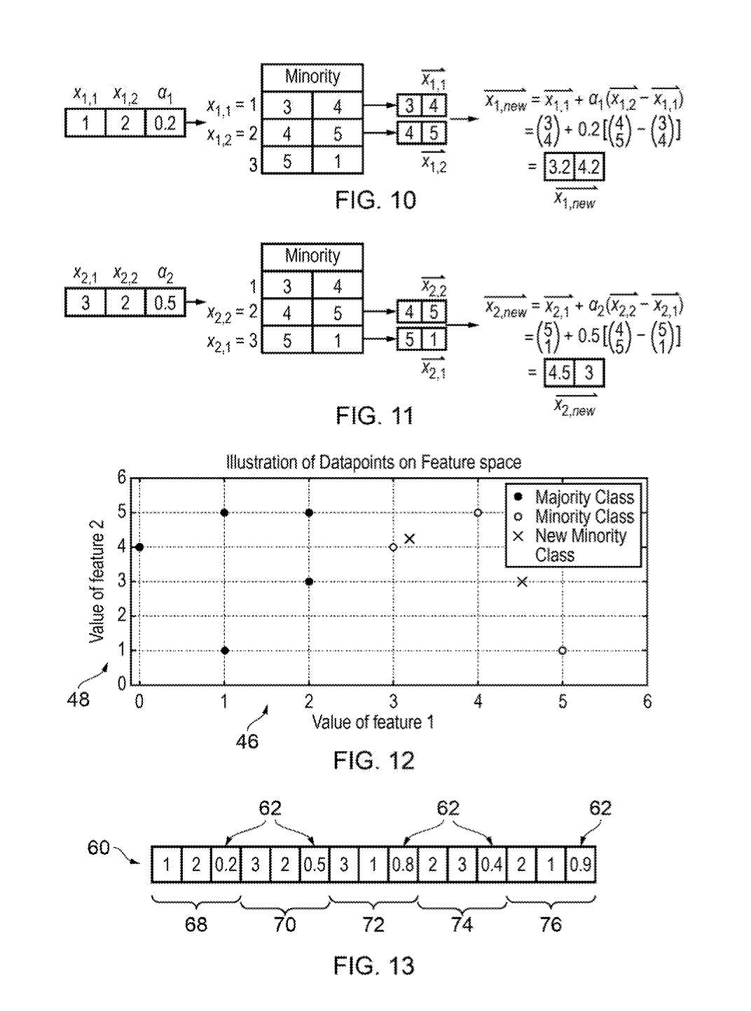

FIG. 10 illustrates an example of the algorithm illustrated in FIG. 9 calculating a first new data point using the first chromosome illustrated in FIG. 8 according to an example;

FIG. 11 illustrates an example of the algorithm illustrated in FIG. 9 calculating a second new data point using the first chromosome illustrated in FIG. 8 according to an example;

FIG. 12 illustrates a graph of the data points illustrated in FIGS. 5 and 6 and including the first and second new data points calculated in FIGS. 10 and 11, according to an example;

FIG. 13 illustrates a schematic diagram of another example of a first chromosome;

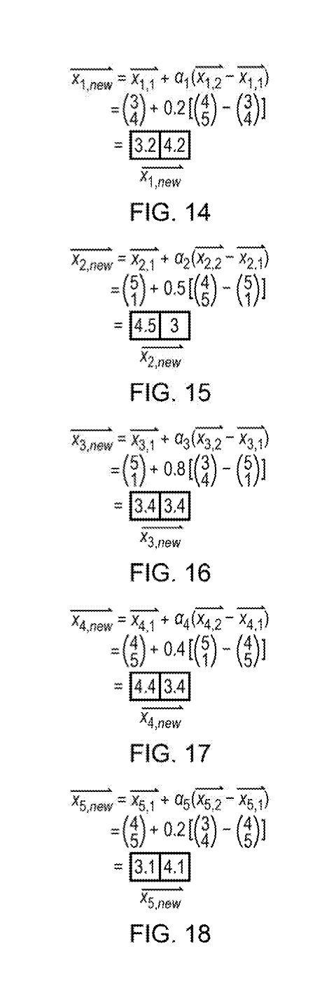

FIG. 14 illustrates an example of the algorithm illustrated in FIG. 9 calculating a first new data point using values in the first chromosome illustrated in FIG. 13 according to an example;

FIG. 15 illustrates an example of the algorithm illustrated in FIG. 9 calculating a second new data point using values in the first chromosome illustrated in FIG. 13 according to an example;

FIG. 16 illustrates an example of the algorithm illustrated in FIG. 9 calculating a third new data point using values in the first chromosome illustrated in FIG. 13 according to an example;

FIG. 17 illustrates an example of the algorithm illustrated in FIG. 9 calculating a fourth new data point using values in the first chromosome illustrated in FIG. 13 according to an example;

FIG. 18 illustrates an example of the algorithm illustrated in FIG. 9 calculating a fifth new data point using values in the first chromosome illustrated in FIG. 13 according to an example;

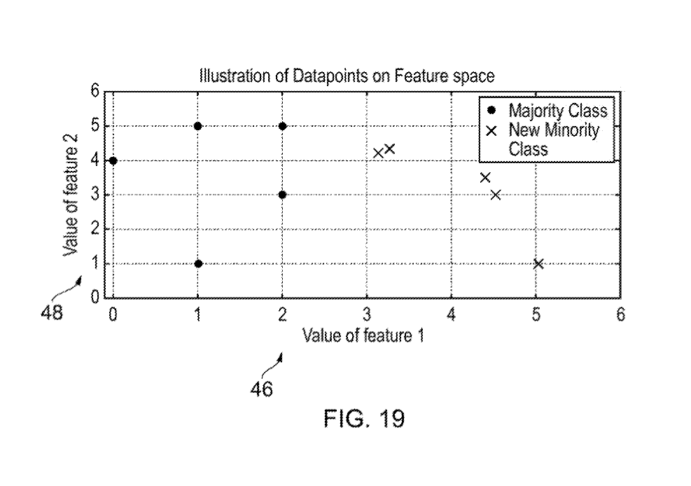

FIG. 19 illustrates a graph of the data points illustrated in FIG. 5 and the first to fifth new data points calculated in FIGS. 14 to 18, according to an example

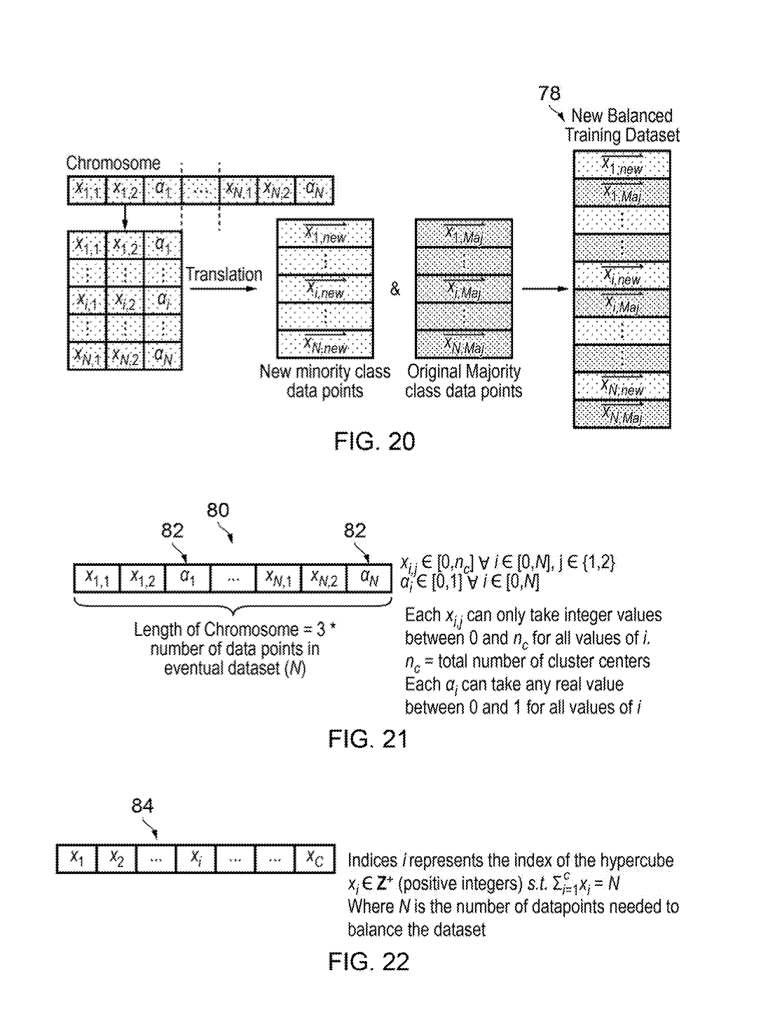

FIG. 20 illustrates a schematic diagram of values in the first chromosome being used to generate a dataset according to various examples;

FIG. 21 illustrates a schematic diagram of a second chromosome according to various examples;

FIG. 22 illustrates a schematic diagram of a third chromosome according to various examples;

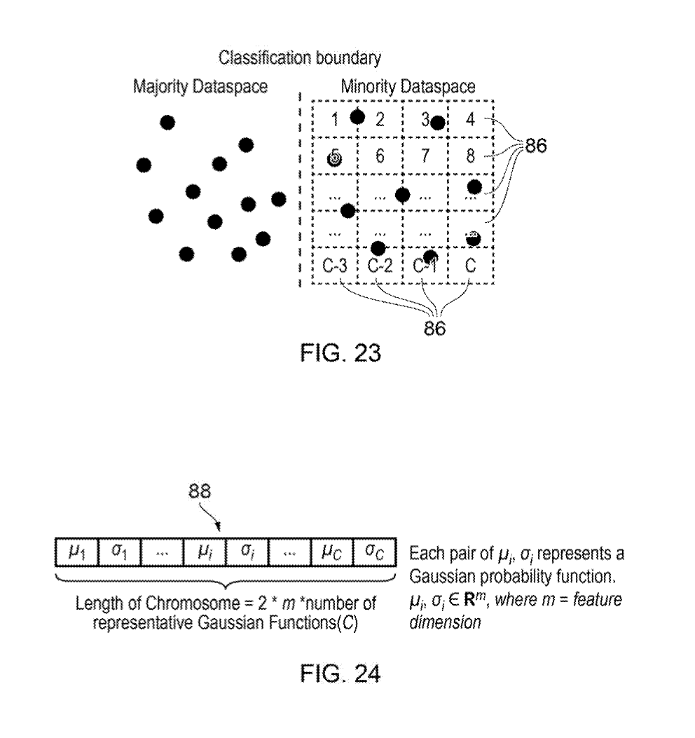

FIG. 23 illustrates a schematic diagram of second category data space segmented into a plurality of hypervolumes according to various examples;

FIG. 24 illustrates a schematic diagram of a fourth chromosome according to various examples;

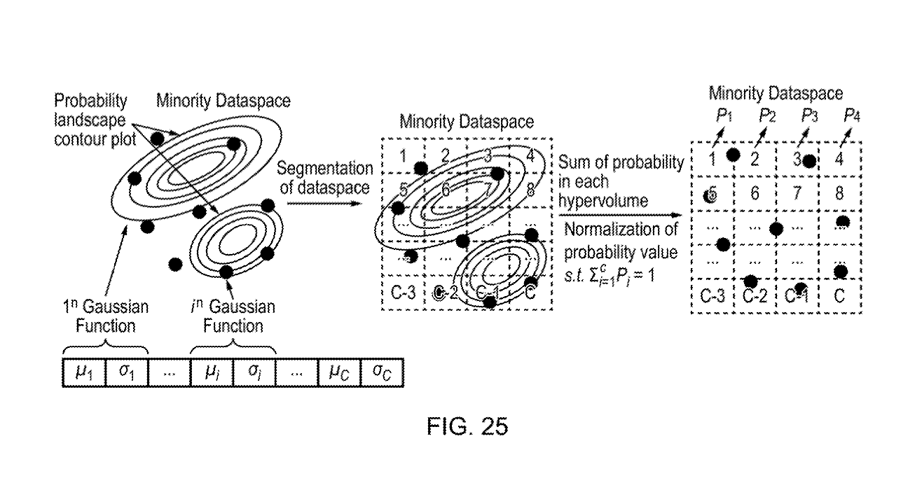

FIG. 25 illustrates a schematic diagram of the fourth chromosome translated into probabilities within a plurality of hypervolumes;

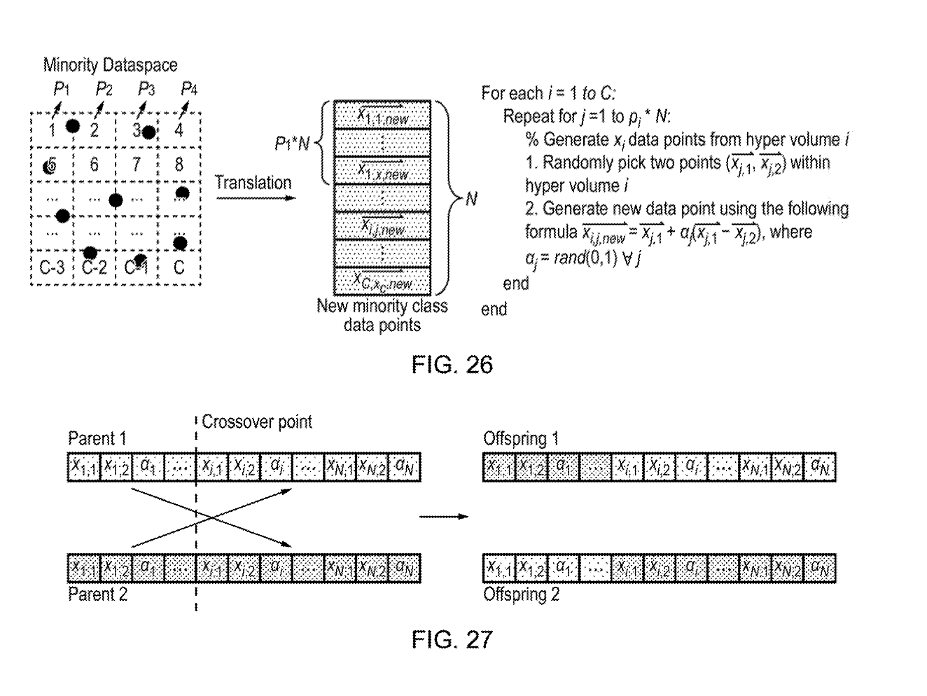

FIG. 26 illustrates a schematic diagram of the probabilities within the plurality of hypervolumes generating a dataset;

FIG. 27 illustrates a schematic diagram of a crossover operation according to various examples;

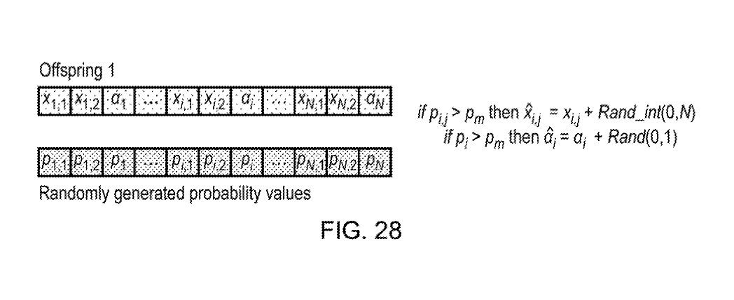

FIG. 28 illustrates a schematic diagram of a mutation operation according to various examples;

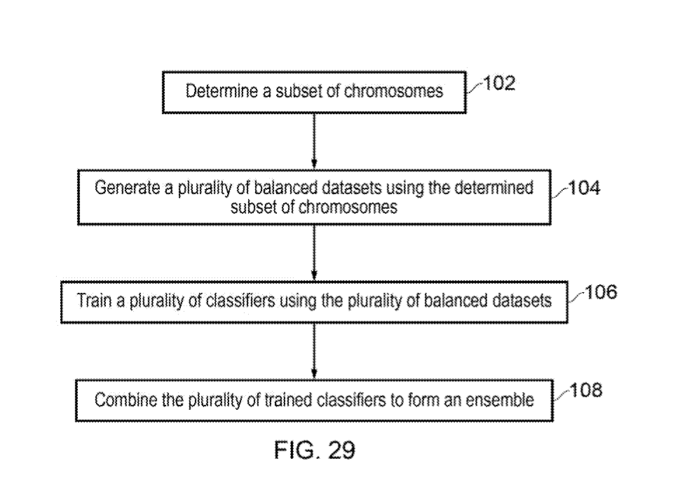

FIG. 29 illustrates a flow diagram of a machine learning method according to various examples;

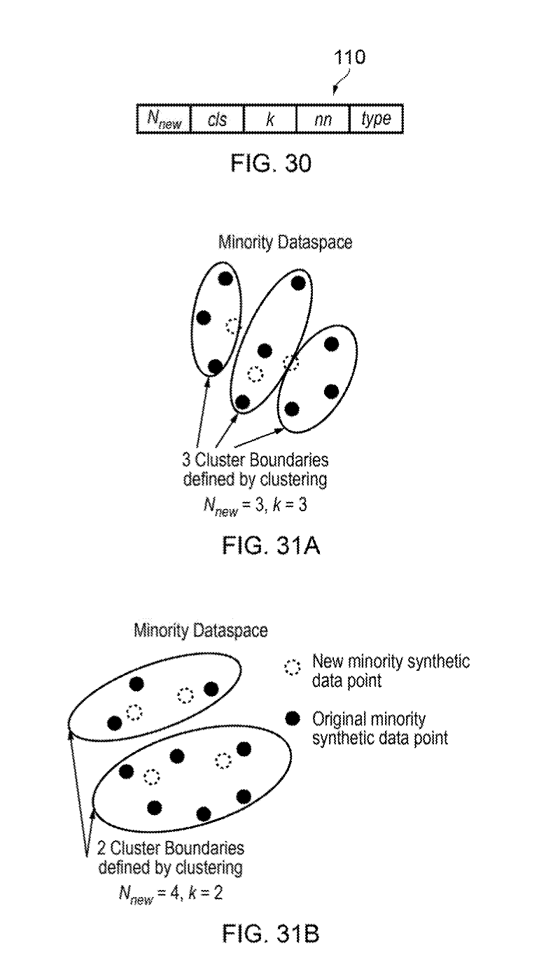

FIG. 30 illustrates a schematic diagram of a fifth chromosome according to various examples;

FIGS. 31A and 31B illustrate schematic diagrams of second category data spaces segmented into a first and second cluster arrangements respectively according to various examples;

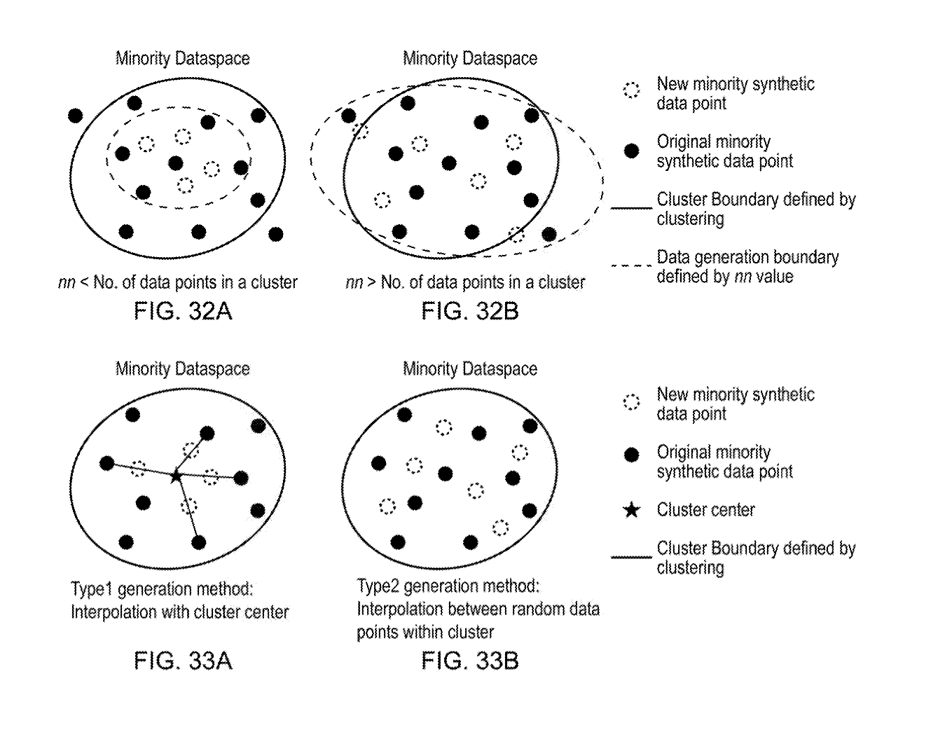

FIGS. 32A and 32B illustrate schematic diagrams of second category data spaces having first and second data generation boundaries respectively according to various examples; and

FIGS. 33A and 33B illustrate schematic diagrams of second category data spaces where synthetic data points are generated according to first and second data generation methods respectively.

### DETAILED DESCRIPTION

In the following description, the terms ‘connected’ and ‘coupled’ mean operationally connected and coupled. It should be appreciated that there may be any number of intervening components between the mentioned features, including no intervening components between the mentioned features.

In more detail, FIG. 1 illustrates a schematic diagram of a system 10 including a mechanical system 12, apparatus 14 for predicting fault occurrence in the mechanical system 12, and at least one sensor 16 for sensing at least one condition of the mechanical system 12. In summary, the one or more sensors 16 are configured to provide a sensed dataset to the apparatus 14 for the condition of the mechanical system 12. The sensed dataset may be imbalanced (that is, having more data points in one category than in another category) and the apparatus 14 is configured to balance the dataset and then predict fault occurrence in the mechanical system 12, and/or predict fault occurrence in a part of the mechanical system 12. In some examples, the predicted fault occurrence may be used to predict the remaining useful life of the mechanical system 12, or a part of the mechanical system 12.

The mechanical system 12 may be any apparatus or device that includes mechanical components and may also include electrical components. For example the mechanical system 12 may be (but is not limited to) a gas turbine engine, an internal combustion engine, a wind turbine, a hydro-electric turbine. The mechanical system 12 may be a module of an apparatus or a device. As used herein, the wording ‘module’ refers to a device or apparatus where one or more features are included at a later time, and possibly, by another manufacturer or by an end user. For example, where the mechanical system 12 is a module of a gas turbine engine, the mechanical system 12 may be a turbine module or a compressor module. The mechanical system 12 may be a part or a component of an apparatus or device. For example, where the mechanical system 12 is a component of a gas turbine engine, the mechanical system 12 may be (for example) a shaft, a fan, a disc, or a blade of the gas turbine engine. In other examples, the system 10 may include an electrical system 12 that comprises or consists of electrical components. For example, the electrical system 12 may be the electrical system of a gas turbine engine, the electrical system of an aircraft, or may be the electrical system of a power plant.

The apparatus 14 includes processor circuitry 18, a user input device 20, and an output device 22. In some examples, the apparatus 14 may be a module. Where the apparatus 14 is a module, the apparatus 14 may only include the processor circuitry 18, and the remaining features may be added by another manufacturer, or by an end user.

The processor circuitry 18, the user input device 20, the output device 22 and the sensors 16 may be coupled to one another via a wireless link and may consequently comprise transceiver circuitry and one or more antennas to enable wireless communication. Additionally or alternatively, the processor circuitry 18, the user input device 20, the output device 22 and the sensors 16 may be coupled to one another via a wired link and may consequently comprise interface circuitry (such as a Universal Serial Bus (USB) socket). It should be appreciated that the processor circuitry 18, the user input device 20, the output device 22, and the sensors 16 may be coupled to one another via any combination of wired and wireless links.

The processor circuitry 18 may comprise any suitable circuitry to cause performance of the methods described herein and as illustrated in FIGS. 2, 3, and 29. The processor circuitry 18 may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller; and/or a central processor unit (CPU); and/or a graphics processor unit (GPU), to perform the methods.

By way of an example, the processor circuitry 18 may comprise at least one processor 24 and at least one memory 26. The memory 26 stores a computer program 28 comprising computer readable instructions that, when read by the processor 24, causes performance of the methods described herein, and as illustrated in FIGS. 2, 3 and 29. The computer program 28 may be software or firmware, or may be a combination of software and firmware. The memory 26 also stores a machine learning computer program 30 and an evolutionary algorithm 31. The machine learning computer program 30 (which may also be referred to as a machine learning tool) is configured to provide a mathematical model to describe the data based on data distribution/statistical distribution of the data. Example machine learning tools include Decision Trees, Support Vector Machines and Neural Networks.

The processor 24 may be located on the mechanical system 12, or may be located remote from the mechanical system 12, or may be distributed between the mechanical system 12 and a location remote from the mechanical system 12. The processor 24 may include at least one microprocessor and may comprise a single core processor, multiple processor cores (such as a dual core processor or a quad core processor) or may comprise a plurality of processors (at least one of which may comprise multiple processor cores).

The memory 26 may be located on the mechanical system 12, or may be located remote from the mechanical system 12, or may be distributed between the mechanical system 12 and a location remote from the mechanical system 12. The memory 26 may be any suitable non-transitory computer readable storage medium, data storage device or devices, and may comprise a hard disk and/or solid state memory (such as flash memory). The memory 26 may be permanent non-removable memory, or may be removable memory (such as a universal serial bus (USB) flash drive).

The computer program 28 may be stored on a non-transitory computer readable storage medium 32. The computer program 28 may be transferred from the non-transitory computer readable storage medium 32 to the memory 26. The non-transitory computer readable storage medium 32 may be, for example, a USB flash drive, a compact disc (CD), a digital versatile disc (DVD) or a Blu-ray disc. In some examples, the computer program 28 may be transferred to the memory 26 via a wireless signal 34 or via a wired signal 34.

The user input device 20 may comprise any suitable device for enabling an operator to at least partially control the apparatus 14. For example, the user input device 20 may comprise one or more of a keyboard, a keypad, a touchpad, a touchscreen display, and a computer mouse. The processor circuitry 18 is configured to receive signals from the user input device 20.

The output device 22 may be any suitable device for conveying information to a user. For example, the output device 22 may be a display (such as a liquid crystal display, or a light emitting diode display, or an active matrix organic light emitting diode display, or a thin film transistor display, or a cathode ray tube display), and/or a loudspeaker, and/or a printer (such as an inkjet printer or a laser printer). The processor circuitry 18 is configured to provide a signal to the output device 22 to cause the output device 22 to convey information to the user.

The at least one sensor 16 is configured to sense at least one condition of the mechanical system 12. The processor circuitry 18 is configured to receive the data from the at least one sensor 16 and may store the data as a dataset in the memory 26 (where the dataset is a collection of data received from the at least one sensor 16 over a period of time). The sensors 16 may comprise any suitable sensor or combination of sensors. For example, the sensors 16 may be configured to sense temperature, pressure, velocity, acoustic emissions, electromagnetic emissions, of a part of the mechanical system 12.

It should be appreciated that the methods illustrated in FIGS. 2, 3, and 29 and described below may be performed ‘offline’ on data which has been measured and recorded previously. Alternatively it may be performed in ‘real-time’, that is, substantially at the same time that the data is measured. In this case the processor circuitry 18 may be coupled to the mechanical system 12. Where the mechanical system 12 forms part of a gas turbine engine (or is the gas turbine engine), the processor circuitry 18 may be an electronic engine controller or another on-board processor. Where the gas turbine engine powers an aircraft, the processor circuitry 18 may be an engine controller, a processor on-board the engine, or a processor on-board the aircraft.

The operation of the system 10 according to various examples is described in the following paragraphs with reference to FIG. 2. The method illustrated in FIG. 2 may be initiated by an operator using the user input device 20.

At block 36, the method includes receiving a first dataset of mechanical system condition data, the first dataset being imbalanced by having more data points in a first category than in a second category. For example, the processor circuitry 18 may receive a first dataset from the at least one sensor 16 that includes condition data of a gas turbine engine 12. The received first dataset is imbalanced and includes a greater number of data points that represent a non-faulty condition than data points that represent a faulty condition.

At block 38, the method includes generating a plurality of chromosomes from the second category data points in the first dataset. The plurality of generated chromosomes includes information to enable the creation of new datasets. For example, the information to enable the creation of new datasets may include an interpolation factor, information for the number of new data points to be generated within a hypervolume, or a probability landscape to enable generation of new data points. The length of the chromosomes may not be restricted to be equal to the number of data points within the received first dataset.

In more detail, the information enables the apparatus 14 to generate new data points from the second category data points in the first dataset. For example, the processor circuitry 18 may separate the received first dataset into first category data points and second category data points. The processor circuitry 18 may then generate a plurality of chromosomes from the second category data points in the first dataset received from the sensors 16.

At block 40, the method includes generating a second dataset using the plurality of chromosomes and the evolutionary algorithm 31, the second dataset being less imbalanced than the first dataset by comprising more second category data points than the first dataset. In some examples, block 40 may include iteratively generating a plurality of datasets using the evolutionary algorithm 31 and the plurality of generated chromosomes, and then selecting the second dataset from the plurality of iteratively generated datasets. For example, the processor circuitry 18 may generate the second dataset using the plurality of chromosomes generated in block 38 and the evolutionary algorithm 31.

The evolutionary algorithm may be a single objective evolutionary algorithm where the second dataset is optimized for a single evaluation metric (for example, accuracy, precision, recall, Area Under the Curve (AUC), Geometric Mean (G-Mean), and so on. The evolutionary algorithm may alternatively be a multi-objective evolutionary algorithm (for example, multi-objective evolutionary algorithm based on decomposition (MOEA/D), non-dominated sorting genetic algorithm-11 (NSGA-II), and so on.

At block 42, the method includes predicting fault occurrence in the mechanical system 12 using the second dataset and the machine learning tool 30. For example, the processor circuitry 18 may predict fault occurrence in the mechanical system 12 using the second dataset generated at block 40 and the machine learning tool 30. In some examples, the machine learning tool 30 may use the second dataset generated at block 40 to train a classifier to obtain better accuracy in predicting fault occurrence in the mechanical system 12.

Where the mechanical system 12 is a gas turbine engine, the processor circuitry 18 may predict fault occurrence in the gas turbine engine. Where the mechanical system 12 is a module of a gas turbine engine (such as a turbine module), the processor circuitry 18 may predict fault occurrence in the module. Where the mechanical system 12 is a component of a gas turbine engine (such as a fan blade for example), the processor circuitry 18 may predict fault occurrence in the component.

The fault occurrence of the mechanical system 12 predicted in block 42 using the second dataset may be more accurate than where fault occurrence is predicted using the first dataset. The second dataset being more balanced than the first dataset enables the machine learning tool 30 to more accurately categorise a data point as being in the first category (for example, a non-faulty condition) or in the second category (for example, a faulty condition).

At block 44, the method includes controlling presentation of the predicted fault occurrence in the mechanical system. For example, the processor circuitry 18 may control a display of the output device 22 to display the predicted fault occurrence of the mechanical system 12 to an operator. By way of another example, the processor circuitry 18 may control a printer of the output device 22 to print the predicted fault occurrence of the mechanical system 12 on a printing medium (such as paper) for viewing by an operator. The operator may then schedule maintenance of the mechanical system 12 to replace or repair the mechanical system 12.

FIG. 3 illustrates a flow diagram of a method of balancing a dataset according to various examples.

At block 36, the processor circuitry 18 receives an imbalanced first dataset from the sensors 16. For example, the processor circuitry 18 may receive the first dataset illustrated in FIGS. 4, 5 and 6 which comprises five data points in a first category (illustrated as solid circles) and three data points in a second category (illustrated as hollow circles). It should be appreciated that the first dataset illustrated in FIGS. 4, 5 and 6 is imbalanced because it has more data points in the first category than in the second category. It should also be appreciated that the first dataset includes relatively few data points for clarity purposes and that other datasets received by the processor circuitry 18 may comprise more (or less) data points.

In more detail, FIG. 4 illustrates a graph of the data points on a feature space. For example, in the context of gas turbine engines, typical features may include temperature, pressure, speed, fuel flow rate, and so on. The graph includes a horizontal axis 46 for the value of a first feature, and a vertical axis 48 for the value of a second feature. FIG. 5 illustrates a table 49 for the five data points in the first category and includes a first column 50 for the data point number, a second column 52 for the value of the first feature, and a third column 54 for the value of the second feature. FIG. 6 illustrates a table 55 for the three data points in the second category and also includes a first column 50 for the data point number, a second column 52 for the value of the first feature, and a third column 54 for the value of the second feature.

At block 56, the method includes splitting the first dataset received at block 36 into a training dataset and a validation dataset. For example, the processor circuitry 18 may split the first dataset into a training dataset and a validation set using random sampling, stratified sampling, K-fold cross validation, or stratified K-fold cross validation. The use of stratified sampling to split the first dataset may advantageously retain the original ratio of second category data points to first category data points.

At block 58, the processor circuitry 18 generates a plurality of chromosomes from the second category data points in the first dataset. The chromosomes include information to enable the creation of new datasets. Performance of block 58 results in the random generation of an initial population of chromosomes. The total number of chromosomes generated is dependent on the population size defined by the operator (for example, the operator may input the population size using the user input device 20). The chromosomes in the initial population may be any one of, or combination of, the chromosomes illustrated in FIGS. 7, 21, 22 and 24 which are described in detail in the following paragraphs.

At block 59, the processor circuitry 18 determines fitness values of individual chromosomes in the population using the initial population of chromosomes generated in block 58, the validation dataset, and the training dataset from block 56. The processor circuitry 18 may first generate new datasets from the chromosomes as described in the following paragraphs.

In some examples, the processor circuitry 18 may generate new second category data points that compensate for the deficit in the number of second category data points in the first dataset relative to the number of first category data points. In other examples, the processor circuitry 18 may generate new second category data points that replace the original second category data points in the first dataset and have the same number (or a similar number) of data points as the first category data points. An operator may operate the user input device 20 to select one of the above mentioned options for generating second category data points.

In the following example, the processor circuitry 18 is configured to generate new second category data points that compensate for the deficit in the number of second category data points in the first dataset relative to the number of first category data points (that is, the original second category data points are retained in the new dataset).

FIG. 7 illustrates a schematic diagram of a first chromosome 60 according to various examples. The first chromosome 60 comprises one or more groups of three values (x_{i,1}, x_{i,2}, αᵢ), where each group represents a new data point in the dataset being generated, and x_{i,1} and x_{i,2} have integer values that represent the indices of the original second category data points. The value αᵢ is an interpolation factor 62 that enables the processor circuitry 18 to generate a new data point that is located between the original two data points in the feature space. The interpolation factor 62 is randomly selected and may have any value between zero and one.

FIG. 8 illustrates an example of the first chromosome 60 illustrated in FIG. 7 including the second category data points in the table of FIG. 6. The first chromosome includes a first group 64 to generate a first data point, and a second group 66 to generate a second data point. The first group 64 includes an interpolation factor having a value of 0.2, and the second group 66 includes an interpolation factor having a value of 0.5.

FIG. 9 illustrates an algorithm 64 for calculating a new data point according to various examples. In summary, a new second category data point may be determined from the first chromosome using the following algorithm:

x_{i,new} =x_{i,1}+αᵢ(x_{i,2}−x_{i,1})

FIG. 10 illustrates an example of the algorithm illustrated in FIG. 9 calculating a first new data point using the first chromosome illustrated in FIG. 8. For example, the processor circuitry 18 may use the algorithm with the first group 64 of the first chromosome 60 to generate a new data point (x_{1,new}) having a value of 3.2 for the first feature, and a value of 4.2 for the second feature.

In examples where the feature can only take either a range of values (for example, integers, binary, or real numbers within a range), interpolation between two existing data points may result in an invalid new data point. In such examples, an additional method block may be required to ensure the new data point complies with the expected value type. This may be achieved by rounding and thresholding.

By way of an example with reference to FIG. 10, if the values of the features can only take integer values between 0-3, then the value of the second feature (4.2, which is a real number which exceeds the range of values), may be rounded down and set to the maximum threshold value (that is, 4.2 is rounded down and set to the maximum threshold value of 3). Additionally, the value of the first feature (3.2 which is a real number which exceeds the range of values), may be rounded down to 3 and thus set at the maximum threshold value.

FIG. 11 illustrates an example of the algorithm illustrated in FIG. 9 calculating a second new data point using the first chromosome illustrated in FIG. 8. For example, the processor circuitry 18 may use the algorithm with the second group 66 of the first chromosome 60 to generate a new data point (x_{2,new}) having a value of 4.5 for the first feature, and a value of 3 for the second feature.

FIG. 12 illustrates a graph of the data points illustrated in FIGS. 5 and 6 and including the first and second new data points. The graph illustrated in FIG. 12 is similar to the graph illustrated in FIG. 4 and therefore includes a horizontal axis 46 for the value of a first feature, and a vertical axis 48 for the value of a second feature. The graph includes five solid circles for the original five first category data points, three hollow circles for the original three second category data points, and two crosses (x) for the two new second category data points.

In the following example, the processor circuitry 18 is configured to generate new second category data points that replace the original second category data points in the first dataset and have the same number (or a similar number) as the number of first category data points.

FIG. 13 illustrates an example of the first chromosome 60 illustrated in FIG. 7 including the second category data points in the table of FIG. 6. The first chromosome includes a first group 68 to generate a first data point, a second group 70 to generate a second data point, a third group 72 to generate a third data point, a fourth group 74 to generate a fourth data point, and a fifth group 76 to generate a fifth data point. The first group 68 includes an interpolation factor having a value of 0.2, the second group 70 includes an interpolation factor having a value of 0.5, the third group 72 includes an interpolation factor having a value of 0.8, the fourth group 74 includes an interpolation factor having a value of 0.4, and the fifth group 76 includes an interpolation factor having a value of 0.9.

As described in the preceding paragraphs (and as illustrated in FIG. 9), new second category data points may be determined from the first chromosome 60 illustrated in FIG. 13 using the algorithm:

x_{1,new} =x_{i,1}+αᵢ(x_{i,2}−x_{i,1})

FIG. 14 illustrates an example of the algorithm illustrated in FIG. 9 being used to calculate a first new data point using the first chromosome illustrated in FIG. 13. For example, the processor circuitry 18 may use the algorithm with the first group 68 of the first chromosome 60 to generate a new data point (x_{1,new}) having a value of 3.2 for the first feature, and a value of 4.2 for the second feature.

FIG. 15 illustrates an example of the algorithm illustrated in FIG. 9 being used to calculate a second new data point using the first chromosome illustrated in FIG. 13. For example, the processor circuitry 18 may use the algorithm with the second group 70 of the first chromosome 60 to generate a new data point (x_{2,new}) having a value of 4.5 for the first feature, and a value of 3 for the second feature.

FIG. 16 illustrates an example of the algorithm illustrated in FIG. 9 being used to calculate a third new data point using the first chromosome illustrated in FIG. 13. For example, the processor circuitry 18 may use the algorithm with the third group 72 of the first chromosome 60 to generate a new data point (x_{3,new}) having a value of 3.4 for the first feature, and a value of 3.4 for the second feature.

FIG. 17 illustrates an example of the algorithm illustrated in FIG. 9 being used to calculate a fourth new data point using the first chromosome illustrated in FIG. 13. For example, the processor circuitry 18 may use the algorithm with the fourth group 74 of the first chromosome 60 to generate a new data point (x_{4,new}) having a value of 4.4 for the first feature, and a value of 3.4 for the second feature.

FIG. 18 illustrates an example of the algorithm illustrated in FIG. 9 being used to calculate a fifth new data point using the first chromosome illustrated in FIG. 13. For example, the processor circuitry 18 may use the algorithm with the fifth group 76 of the first chromosome 60 to generate a new data point (x_{5,new}) having a value of 3.1 for the first feature, and a value of 4.1 for the second feature.

FIG. 19 illustrates a graph of the data points illustrated in FIG. 5 and the first to fifth new data points. The graph illustrated in FIG. 19 is similar to the graphs illustrated in FIGS. 4 and 12 and includes a horizontal axis 46 for the value of a first feature, and a vertical axis 48 for the value of a second feature. The graph includes five solid circles for the original five first category data points, and five crosses (x) for the five new second category data points.

FIG. 20 illustrates a schematic diagram of the first chromosome being used to generate a new balanced training dataset 78 according to various examples. The processor circuitry 18 is configured to combine the new second category data points (such as those calculated in FIGS. 10, 11 or 14 to 18) with the original first category data points (such as those illustrated in FIG. 5) to form the new dataset 78. It should be appreciated that the new dataset 78 is more balanced than the first dataset because the number of second category data points is closer to, or the same as, the number of first category data points.

In some examples, all chromosomes from each population generation is translated into a balanced training dataset. Each of these balanced training datasets are used to train a machine learning algorithm. The performance (for example, accuracy) of the machine learning algorithm on the validation set is then assigned as the fitness value of the respective chromosome. After iterating through a number of generations, the fitness values gradually improve. At the end of the method, the chromosome with the best fitness value is used to generate a balanced dataset.

FIG. 21 illustrates a schematic diagram of a second chromosome 80 according to various examples. The second chromosome 80 differs from the first chromosome 60 in that the second chromosome 80 defines the location of clusters of the second category data points. The second chromosome 80 comprises one or more groups of three values (x_{i,1}, x_{i,2}, αᵢ), where each group represents a new data point in the dataset to be generated, and x_{i,1} and x_{i,2} have integer values that represent the indices associated with the cluster centres. The value αᵢ is an interpolation factor 82 that enables the processor circuitry 18 to generate a new data point that is located between two original cluster centres. New second category data points may be generated as described above using the formula:

x_{i,new} =x_{i,1}+αᵢ(x_{i,2}−x_{i,1})

FIG. 22 illustrates a schematic diagram of a third chromosome 84 according to various examples. The third chromosome 84 differs from the first and second chromosomes 60, 80 in that the third chromosome 84 is generated from an indirect encoding method where the feature/data space is segmented into a number of hypervolumes 86 (as illustrated in FIG. 23). The length of the third chromosome 84 is set to be equal to the number of hypervolumes 86. That is, the third chromosome 84 comprises a plurality of values xᵢ, where i represents the index of the hypervolume. The value of xᵢ at each location represents the number of new data points to be generated from within the associated hypervolume. Consequently, xᵢ has positive integer values and the sum of all xᵢ is equal to the number of data points to balance the first dataset.

New second category data points may be generated from the third chromosome 84 using any suitable method. For example, the processor circuitry 18 may use random resampling or synthetic minority oversampling technique (SMOTE) to generate new second category data points. The processor circuitry 18 may then generate a new balanced training dataset using the original first category data points and the new second category data points.

FIG. 24 illustrates a schematic diagram of a fourth chromosome 88 according to various examples. The fourth chromosome 88 differs from the first and second chromosomes 60, 80 in that the fourth chromosome 88 is generated from an indirect encoding method that maps the importance of data/feature space generation sites as a probability landscape (formed from a plurality of Gaussian functions summed up to form a probability landscape). A probability generated from the landscape represents the probability at a location for generating new data points to balance the dataset. The fourth chromosome 88 includes a plurality of μᵢ, σᵢ pairs that represent a plurality of Gaussian probability functions.

As illustrated in FIG. 25, the probability landscape in the minority data/feature space is segmented into a plurality of hypervolumes. Within each hypervolume, the sum of probabilities or maximum probability value is then calculated. The probability values are then normalized such that the sum of all probabilities in each hypervolume equals to one. FIG. 26 illustrates the process of translating the probability values into new second category data points which may then be combined with the original first category data points to form a new balanced training dataset.

After generating the new balanced training dataset, the processor circuitry 18 uses the new balanced training dataset to train the machine learning computer program 30. It should be appreciated that any learning method may be used by the machine learning computer program 30 at block 59.

The processor circuitry 18 then uses the trained machine learning computer program 30 to determine a fitness value of the chromosomes in the initial population of chromosomes by using the validation dataset (from block 56), an evaluation metric (for example, accuracy, Area Under the Curve (AUC), and so on), and the new datasets generated from the initial population of chromosomes.

At block 90, the processor circuitry 18 performs a mating selection using the initial population of chromosomes generated at block 58, the fitness values determined at block 59, and a pre-defined number of chromosomes in the mating pool (which may be defined by the operator using the user input device 20). In more detail, the processor circuitry 18 selects a subset of chromosomes from the initial population of chromosomes (the subset size being defined by the mating pool size) based on their fitness values (where chromosomes having higher fitness values have a higher probability of being selected into the mating pool by the processor circuitry 18).

At block 92, the processor circuitry 18 performs crossover and mutation on the chromosomes in the mating pool (that is, the subset of chromosomes selected at block 90) to generate offspring chromosomes. It should be appreciated that any suitable crossover algorithm may be used by the processor circuitry 18 (such as the crossover algorithm illustrated in FIG. 27). Similarly, it should be appreciated that any suitable mutation algorithm may be used by the processor circuitry 18 (such as the mutation algorithm illustrated in FIG. 28).

At block 94, the processor circuitry 18 performs a fitness evaluation on the offspring chromosomes generated at block 92 to determine a fitness value for the offspring chromosomes. The processor circuitry 18 may perform block 94 as described above with reference to block 59.

At block 96, the processor circuitry 18 performs survivor selection to select one or more chromosomes for passing on to the next generation of chromosomes. It should be appreciated that any suitable survivor selection method may be used. For example, the processor circuitry 18 may use an ‘elitism’ selection method where the chromosomes having the highest fitness values are passed onto the next generation of chromosomes. In more detail, the chromosomes from the original population and the offspring chromosomes may be pooled together and sorted based on their fitness values. The chromosomes having the highest fitness values (that is, the fittest chromosomes) are then chosen to survive to the next generation. The number of chromosomes chosen to survive is dependent on the elitism percentage. In some examples, only a certain percentage of the next generation of chromosomes are ‘elite’ chromosomes and the rest of the population of chromosomes are then randomly selected from the remaining pool of chromosomes.

At block 98, the processor circuitry 18 determines whether a termination condition has been fulfilled. The processor circuitry 18 may use any suitable termination condition and may use, for example, maximum number of generations, the maximum fitness value, and/or the average fitness value of the population of chromosomes. If the termination condition has not been fulfilled, the processor circuitry 18 returns to block 90 and the next generation of chromosomes selected at block 96 forms at least part of the mating pool for mating selection. If the termination condition has been fulfilled, the processor circuitry 18 proceeds to block 100.

At block 100, the processor circuitry 18 selects the chromosome having the highest fitness value (that is, the processor circuitry 18 selects the fittest chromosome) and then generates an optimized balanced dataset from the selected chromosome. The optimized balanced dataset may then be used at block 42 as the second dataset in order to predict fault occurrence in the mechanical system.

In some examples, the processor circuitry 18 may perform the method illustrated in FIG. 29.

At block 102, the method includes determining a subset of the chromosomes from the plurality of chromosomes. The subset of chromosomes includes those chromosomes that are closest to the chromosome selected at block 100 (and may or may not include the selected chromosome). For example, subsequent to block 100, the processor circuitry 18 may select a subset of chromosomes having fitness values above a threshold fitness value. By way of another example, the processor circuitry 18 may select a predetermined number of chromosomes that have fitness values closest to the fitness value of the chromosome selected at block 100.

At block 104, the method includes generating a plurality of balanced datasets using the subset of chromosomes determined at block 102.

At block 106, the method includes training a plurality of classifiers using the plurality of balanced datasets generated at block 104. For example, the processor circuitry 18 may train the plurality of classifiers using the plurality of generated balanced datasets to train the machine learning algorithm 30.

At block 108, the method includes combining the plurality of trained classifiers to form an ensemble which may then be used to predict fault occurrence in the mechanical system 12 at block 42 (illustrated in FIG. 2).

The apparatus 14 and methods illustrated in FIGS. 2, 3, and 29 provide several advantages.

First, the methods illustrated in FIGS. 2 and 3 may result in more optimally balanced datasets than existing wrapper methods because with each iteration/generation of the evolutionary algorithm, suitable data points are generated and retained while unsuitable data points are discarded. Existing wrapper methods instead make use of repetitive resampling of existing data points to balance the dataset. This may lead to skewing of the original data distribution.

Second, when compared with non-wrapper methods, the methods illustrated in FIGS. 2 and 3 may be more effective in delivering a more optimal solution (due to the feedback within the method). Consequently, through this single iterative step, the generation of additional data points and the discarding of data points are encapsulated in a single step. In existing non-wrapper methods, new data points are generated regardless of their effectiveness, and for the generated data points to be effective, they usually require an additional step of data cleaning to eliminate some of the generated data points.

Third, it has been found by the inventors that the methods illustrated in FIGS. 2 and 3 measurably improve the quality of prediction of fault occurrence when compared with existing methods.

Fourth, since the length of the chromosomes may not be restricted to be equal to the number of data points within the original dataset (that is, the received first dataset), this may advantageously enable effective optimisation by the evolutionary algorithm.

Fifth, the method illustrated in FIG. 29 may improve the accuracy of predicting fault occurrence in the mechanical system 12.

It will be understood that the invention is not limited to the embodiments above-described and various modifications and improvements can be made without departing from the concepts described herein. For example, the at least one sensor 16 may be configured to sense condition data of a human or an animal instead of the mechanical system 12. In these examples, the apparatus 14 is configured to balance a dataset for the condition of the human or animal to enable a diagnosis to be determined from the balanced dataset.

By way of a further example, a chromosome may only encode; parameters required during clustering; and a data generation method. Such a chromosome may have a reduced length and thus enable more efficient optimisation to be achieved. The clustering may be used to define regions optimal for synthetic oversampling. By tuning the parameters, the regions for synthetic oversampling may be changed accordingly.

FIG. 30 illustrates a schematic diagram of a fifth chromosome 110 according to various examples. The encoding for the fifth chromosome 110 only encodes the parameters required in clustering and data generation. The parameters include ‘N_{new}’, ‘cls’, ‘k’, ‘nn’, and ‘type’.

‘N_{new}’ represents the number of new synthetic data points to be generated. ‘N_{new}’ may be set to be of any integer value. For example, ‘N_{new}’ may be allowed to range between 0 and the number of majority datapoints, ‘cls’ represents the clustering method used and a variety of clustering methods may be selected by a user. ‘k’ represents the number of clusters. ‘k’ may have an allowable range of integers between 0 and Nₘᵢₙ/2 to ensure that at least two data points are within each cluster. ‘nn’ represents the number of nearest neighbours within each cluster for oversampling. This parameter has the effect of either limiting the data generation to be close to the cluster centre or enabling data generation between clusters. ‘type’ specifies the data generation method (for example, type 1, type 2 and so on).

FIGS. 31A and 31B illustrate schematic diagrams of second category data spaces segmented into first and second cluster arrangements respectively according to various examples (that is, the parameters ‘N_{new}’ and ‘k’ are varied).

In more detail, FIG. 31A illustrates a second category data space where ‘N_{new}’ is equal to 3 and ‘k’ is equal to 3. Consequently, FIG. 31A illustrates three new synthetic data points and three cluster boundaries. FIG. 31B illustrates a second category data space where ‘N_{new}’ is equal to 4 and ‘k’ is equal to 2. Consequently, FIG. 31B illustrates four new synthetic data points and two cluster boundaries.

FIGS. 32A and 32B illustrate schematic diagrams of second category data spaces having first and second data generation boundaries respectively according to various examples (that is, the parameter ‘nn’ is varied).

In more detail, FIG. 32A illustrates a second category data space where the data generation boundary is positioned within a cluster boundary. This is an example of where the data generation boundary ‘nn’ is less than the number of data points in the cluster. FIG. 32B illustrates a second category data space where the data generation boundary is outside, and includes, a cluster boundary. This is an examples of where the data generation boundary ‘nn’ is greater than the number of data points in the cluster.

FIGS. 33A and 33B illustrate schematic diagrams of second category data spaces where synthetic data points are generated according to first and second data generation methods respectively (that is, the parameter ‘type’ is varied).

In more detail, FIG. 33A illustrates a second category data space where synthetic data generation is by random interpolation between data points and the cluster centre. This data generation method results in four synthetic data points being generated. FIG. 33B illustrates a second category data space where synthetic data generation is by random interpolation between random pairs of data points within the cluster.

Where an imbalanced dataset includes more than two categories, the dataset may be balanced by sequentially pairing categories together and using the methods described in the preceding paragraphs for each pair of categories.

Except where mutually exclusive, any of the features may be employed separately or in combination with any other features and the disclosure extends to and includes all combinations and sub-combinations of one or more features described herein.

1. A method of predicting fault occurrence in a mechanical system, the method comprising:
receiving a first dataset of mechanical system condition data, the first dataset being imbalanced by having more data points in a first category than in a second category;
generating a plurality of chromosomes from the second category data points in the first dataset; the plurality of chromosomes including information to enable the creation of new datasets;
generating a second dataset using the plurality of chromosomes and an evolutionary algorithm, the second dataset being less imbalanced than the first dataset; and
predicting fault occurrence in the mechanical system using the second dataset and a machine learning algorithm.

2. A method as claimed in claim 1, wherein generating the second dataset includes: iteratively generating a plurality of datasets using the evolutionary algorithm and the plurality of generated chromosomes; and selecting the second dataset from the plurality of iteratively generated datasets.

3. A method as claimed in claim 1, further comprising: generating a plurality of second datasets from a subset of the plurality of chromosomes; training a plurality of classifiers using the plurality of second datasets; combining the plurality of classifiers to form an ensemble; and wherein predicting fault occurrence in the mechanical system uses the ensemble.

4. A method as claimed in claim 1, wherein the information to enable the creation of new datasets includes an interpolation factor.

5. A method as claimed in claim 1, wherein the information to enable the creation of new datasets includes information for the number of new data points to be generated within a hypervolume.

6. A method as claimed in claim 1, wherein the information to enable the creation of new datasets includes a probability landscape to enable generation of new data points.

7. A method as claimed in claim 1, wherein the information to enable the creation of new datasets only encodes parameters for defining clusters and a data generation method.

8. A method as claimed in claim 1, wherein the first category is a non-faulty condition of the mechanical system and the second category is a faulty condition of the mechanical system.

9. A method as claimed in claim 1, further comprising controlling presentation of the predicted fault occurrence in the mechanical system.

10. Apparatus for predicting fault occurrence in a mechanical system, the apparatus comprising: processor circuitry configured to:
receive a first dataset of mechanical system condition data, the first dataset being imbalanced by having more data points in a first category than in a second category;
generate a plurality of chromosomes from the second category data points in the first dataset; the plurality of chromosomes including information to enable the creation of new datasets;
generate a second dataset using the plurality of chromosomes and an evolutionary algorithm, the second dataset being less imbalanced than the first dataset; and
predict fault occurrence in the mechanical system using the second dataset and a machine learning algorithm.

11. Apparatus as claimed in claim 10, wherein the processor circuitry is configured to iteratively generate a plurality of datasets using the evolutionary algorithm and the plurality of generated chromosomes; and select the second dataset from the plurality of iteratively generated datasets.

12. Apparatus as claimed in claim 10, wherein the processor circuitry to configured to: generate a plurality of second datasets from a subset of the plurality of chromosomes; train a plurality of classifiers using the plurality of second datasets; combine the plurality of classifiers to form an ensemble; and wherein predicting fault occurrence in the mechanical system uses the ensemble.

13. Apparatus as claimed in claim 10, wherein the information to enable the creation of new datasets includes an interpolation factor.

14. Apparatus as claimed in claim 10, wherein the information to enable the creation of new datasets includes information for the number of new data points to be generated within a hypervolume.

15. Apparatus as claimed in claim 10, wherein the information to enable the creation of new datasets includes a probability landscape to enable generation of new data points.

16. Apparatus as claimed in claim 10, wherein the information to enable the creation of new datasets only encodes parameters for defining clusters and a data generation method.

17. Apparatus as claimed in claim 10, wherein the first category is a non-faulty condition of the mechanical system and the second category is a faulty condition of the mechanical system.

18. Apparatus as claimed in claim 10, wherein the processor circuitry is configured to control an output device to present the predicted fault occurrence in the mechanical system.

19. Apparatus as claimed in claim 10, wherein the mechanical system comprises a gas turbine engine.

20. A non-transitory computer readable storage medium comprising computer readable instructions that, when read by a computer, causes performance of the method as claimed in claim 1.
